(19) United States
(12) Patent Application Publication
(10) Pub. No.: US 2026/0371051 A1
(43) Pub. Date: Nov. 19, 2026

(54) ELECTRONIC DEVICE AND METHOD FOR PERFORMING NEAR-FIELD COMMUNICATION

(71) Applicant: Samsung Electronics Co., Ltd., Suwon-si (KR)

(72) Inventors: Myeonghwan NAM, Suwon-si (KR); Ingwon HONG, Suwon-si (KR); Byounghak JIN, Suwon-si (KR); Jaehyung SEO, Suwon-si (KR); Moonseok KANG, Suwon-si (KR)

(21) Appl. No.: 19/551,019

(22) Filed: Feb. 26, 2026

Related U.S. Application Data
(63) Continuation of application No. PCT/KR2026/002943, filed on Feb. 23, 2026.

(30) Foreign Application Priority Data
May 19, 2025 (KR) 10-2025-0064465
Jul. 3, 2025 (KR) 10-2025-0089073

(51) Int. Cl. H04W 4/80; H04W 8/18

(52) U.S. Cl. CPC H04W 4/80; H04W 8/18

(57) ABSTRACT

An electronic device is provided. The electronic device includes a near-field communication (NFC) circuit configured to support at least one NFC protocol, at least one processor, and memory storing instructions. The instructions cause the electronic device to obtain a first NFC configuration corresponding to location information of the electronic device and/or a request from an application related to the NFC, determine whether the first NFC configuration is supported by a subscriber identification module (SIM), based on identifying that the first NFC configuration is supported by the SIM, control the NFC circuit to perform NFC operations using the first NFC configuration, and based on identifying that the first NFC configuration is not supported by the SIM, obtain a second NFC configuration supporting NFC execution environments (NFCEE) of a non-SIM type and control the NFC circuit to perform NFC operations using the second NFC configuration.

### CROSS-REFERENCE TO RELATED APPLICATION(S)

This application is a continuation application, claiming priority under 35 U.S.C. § 365(c), of an International application No. PCT/KR2026/002943, filed on Feb. 23, 2026, which is based on and claims the benefit of a Korean patent application number 10-2025-0064465, filed on May 19, 2025, in the Korean Intellectual Property Office, and of a Korean patent application number 10-2025-0089073, filed on Jul. 3, 2025, in the Ministry of Intellectual Property (MOIP), the disclosure of each of which is incorporated by reference herein in its entirety.

### TECHNICAL FIELD

The disclosure relates to an electronic device and method for performing near-field communication (NFC).

### BACKGROUND ART

Due to advances in information communication technology and semiconductor technology, various functions are being integrated into a single portable electronic device (e.g., a smartphone). For example, an electronic device may implement various functions such as not only communication functions, but also entertainment functions such as games, multimedia functions such as music/video playback, communication and security functions for mobile banking, camera functions for capturing images/videos, and functions such as schedule management and electronic wallet. Such electronic devices are being downsized so that users may conveniently carry them, and the various functions provided through the electronic devices are also becoming increasingly sophisticated.

As wireless communication technology develops, various methods for performing communication with external electronic devices using electronic devices are being proposed. Among them, the near-field communication (NFC) method is a method based on a non-contact short-range wireless communication standard that enables wireless communication between electronic devices with relatively low power at a relatively short distance (e.g., within 10 cm) using a designated frequency band (e.g., 13.56MHz). In the NFC method, the transmission speed per second is 424 Kbps, and due to the characteristics of proximity and the use of encryption technology, the NFC method has excellent security and has the advantage of being able to recognize electronic devices in about 1/10 second or less without requiring complex pairing operations for electronic devices to recognize each other.

The NFC method is a smart card-type non-contact wireless communication method utilizing radio frequency identification (RFID) technology, and has the characteristics of having bi-directionality compared to smart cards, having a relatively large usable storage memory space, and having a wide range of applicable services. Accordingly, the NFC method is being applied to various electronic devices such as smartphones. Electronic devices to which the NFC method is applied may be implemented to selectively use reader/writer mode, peer to peer (P2P) mode, and/or card emulation mode.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problems

Aspects of the disclosure are to address at least the above-mentioned problems and/or disadvantages and to provide at least the advantages described below. Accordingly, an aspect of the disclosure is to provide an electronic device and method for performing near-field communication (NFC).

Another aspect of the disclosure is to provide an electronic device and method for determining an NFC configuration including parameters for near-field communication (NFC).

Additional aspects will be set forth in part in the description which follows and, in part, will be apparent from the description, or may be learned by practice of the presented embodiments.

In accordance with another aspect of the disclosure, an electronic device is provided. The electronic device includes a near-field communication (NFC) circuit configured to support at least one NFC protocol, memory storing instructions, and at least one processor communicatively coupled to the NFC circuit and the memory, wherein the instructions, when executed by the at least one processor individually or collectively, cause the electronic device to obtain a first NFC configuration corresponding to at least one of location information of the electronic device or a request from an application related to the NFC, determine whether the first NFC configuration is supported by a subscriber identification module (SIM) included in the electronic device, and based on identifying whether the first NFC configuration is supported by the SIM, control the NFC circuit to perform NFC operations using the first NFC configuration or a second NFC configuration, wherein, based on identifying that the first NFC configuration is supported by the SIM, the instructions, when executed by the at least one processor individually or collectively, cause the electronic device to control the NFC circuit to perform NFC operations using the first NFC configuration, wherein based on identifying that the first NFC configuration is supported by the SIM, the instructions, when executed by the at least one processor individually or collectively, cause the electronic device to obtain the second NFC configuration supporting NFC execution environments (NFCEE) of a non-SIM type and control the NFC circuit to perform NFC operations using the second NFC configuration.

In accordance with another aspect of the disclosure, a method performed by an electronic device is provided. The method includes obtaining a first near-field communication (NFC) configuration corresponding to at least one of location information of the electronic device or a request from an application related to NFC, determining whether the first NFC configuration is supported by a subscriber identification module (SIM) included in the electronic device, based on identifying whether the first NFC configuration is supported by the SIM, performing NFC operations using the first NFC configuration or a second NFC configuration, wherein the performing NFC operations based on identifying that the first NFC configuration is supported by the SIM, performing NFC operations using the first NFC configuration, and based on identifying that the first NFC configuration is not supported by the SIM, obtaining the second NFC configuration supporting NFC execution environments (NFCEE) of a non-SIM type and performing NFC operations using the second NFC configuration.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining a first near-field communication (NFC) configuration corresponding to at least one of location information of the electronic device or a request from an application related to NFC, determining whether the first NFC configuration is supported by a subscriber identification module (SIM) included in the electronic device, and based on identifying whether the first NFC configuration is supported by the SIM, performing NFC operations using the first NFC configuration or a second NFC configuration, wherein the performing NFC operations include based on identifying that the first NFC configuration is supported by the SIM, performing NFC operations using the first NFC configuration, and based on identifying that the first NFC configuration is not supported by the SIM, obtaining the second NFC configuration supporting NFC execution environments (NFCEE) of a non-SIM type and performing NFC operations using the second NFC configuration.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a view illustrating a network environment based on subscription identification according to an embodiment of the disclosure;

FIG. 3 is a block view illustrating a configuration of an electronic device for near-field communication (NFC) according to an embodiment of the disclosure;

FIG. 4 is a block view illustrating a configuration of an NFC reader according to an embodiment of the disclosure;

FIG. 5 is a view illustrating NFC configuration management according to an embodiment of the disclosure;

FIG. 6 is a view illustrating various NFC execution environments according to an embodiment of the disclosure;

FIG. 7 is a flowchart illustrating determining an NFC configuration according to an embodiment of the disclosure;

FIG. 8 is a flowchart illustrating determining a first NFC configuration according to an embodiment of the disclosure;

FIG. 9 is a flowchart illustrating determining SIM compatibility of an NFC configuration according to an embodiment of the disclosure;

FIG. 10 illustrates a plurality of NFC configurations according to an embodiment of the disclosure;

FIG. 11 illustrates regional NFC configurations according to an embodiment of the disclosure; and

FIGS. 12, 13, 14, 15, 16, 17, 18, and 19 illustrate examples of NFC configurations according to various embodiments of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the terms "first" and "second" may be used to describe various components, but the components should not be limited by the terms. The terms may be used to distinguish one component from another. For example, a first component may be denoted a second component, and vice versa without departing from the scope of the disclosure.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is "directly connected to" or "directly coupled to" another component, no other intervening components may intervene therebetween.

Hereinafter, embodiments of the disclosure will be described in detail with reference to the accompanying drawings. The same reference denotations may be used to refer to the same or substantially the same elements throughout the specification and the drawings. No duplicate description of the same elements is given herein. When determined to make the subject matter of the disclosure unclear, the detailed description of the known art or functions may be skipped. The accompanying drawings are provided for an easier understanding of embodiments of the disclosure but the disclosure should not be limited thereby. It should be interpreted that the disclosure may encompasses all other changes, equivalents, or replacements of those shown in the drawings.

In the disclosure, embodiments are described by taking an electronic device as an example, but the electronic device may also be referred to as a terminal, mobile station, mobile equipment (ME), user equipment (UE), user terminal (UT), subscriber station (SS), wireless device, handheld device, or access terminal (AT). In embodiments of the disclosure, the electronic device may be, e.g., a device having communication functionality, such as a mobile phone, a personal digital assistant (PDA), a smart phone, a wireless modem, or a laptop computer.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

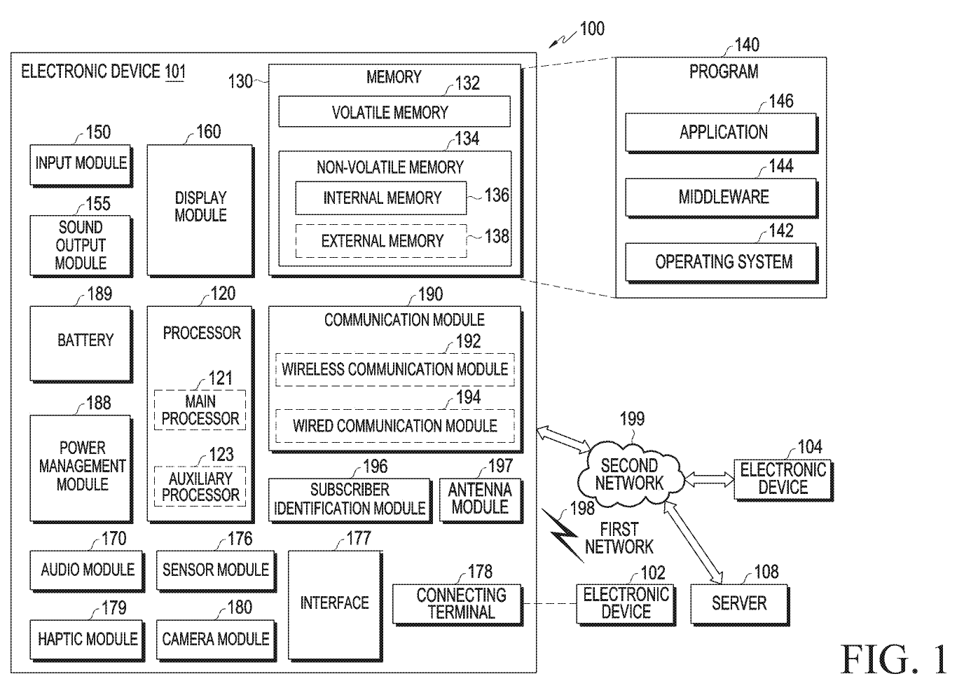

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In an embodiment, the number of processors 120 may be one or more. For example, the processor 120 may have a structure of a multi-core processor such as dual core, quad core, or hexa core.

In an embodiment, the processor 120 may control the operations of the electronic device 101 by executing the instructions stored in the memory 130. For example, the processor 120 may correspond to a plurality of processors that individually perform a plurality of operations or a plurality of processors that divide a plurality of operations between processors and collectively perform the operations.

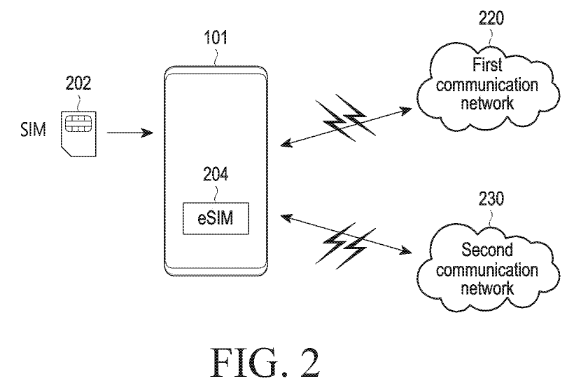

FIG. 2 is a view illustrating a network environment based on subscription identification according to an embodiment of the disclosure.

Referring to FIG. 2, an electronic device (e.g., the electronic device 101 of FIG. 1) may be configured to communicate with a first communication network 220 and/or a second communication network 230. In an embodiment, the electronic device 101 may include a subscriber identification module (SIM) 202 and/or an embedded SIM (eSIM) 204.

In an embodiment, when the electronic device 101 includes the SIM 202, the SIM 202 may be configured as a removable physical card. The electronic device 101 may include a slot (not illustrated) for receiving the SIM 202. According to one embodiment, although not illustrated in FIG. 2, the electronic device 101 may accommodate two or more SIMs through multiple slots for receiving two or more SIMs. In an embodiment, the SIM 202 may include subscription information approved by a communication service provider of the first communication network 220. The electronic device 101 may receive wireless communication service through the first communication network 220 by accessing the first communication network 220 using the SIM 202.

In an embodiment, when the electronic device 101 includes the eSIM 204, the eSIM 204 may also be referred to as an embedded UICC (eUICC). The electronic device 101 may activate the eSIM 204 by downloading a subscription profile related to the eSIM 204 from a communication service provider server. In an embodiment, the eSIM 204 may include subscription information approved by a communication service provider of the second communication network 230. After the eSIM 204 is activated, the electronic device 101 may receive wireless communication service through the second communication network 230 by accessing the second communication network 230 using the eSIM 204.

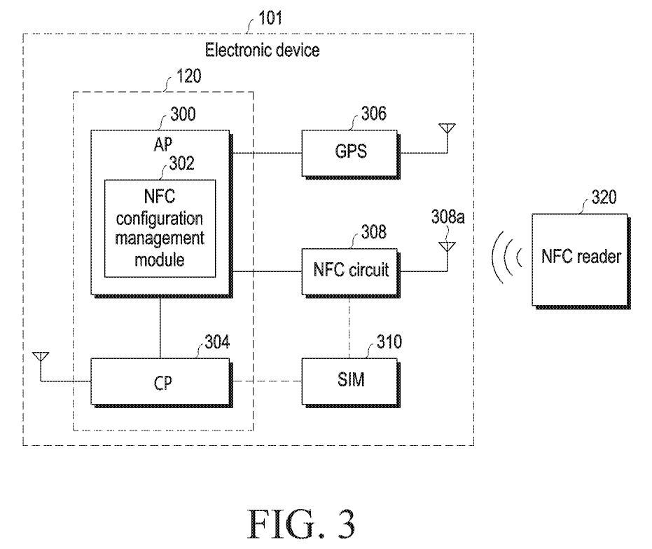

FIG. 3 is a block view illustrating a configuration of an electronic device for near-field communication (NFC) according to an embodiment of the disclosure.

Referring to FIG. 3, an electronic device (e.g., the electronic device 101 of FIG. 1) may include an NFC circuit 308 configured to communicate with an external electronic device (e.g., an NFC reader 320) based on an NFC method. In describing embodiments of the disclosure, reference is made to the 14443 standard and 18092 standard defined by the International Organization for Standardization (ISO)/International Electrotechnical Commission (IEC), and the Japanese Industrial Standards (JIS) X 6319-4 standard, but embodiments of the disclosure may also be applied to other communication systems having similar technical backgrounds with slight modifications within a scope that does not greatly depart from the scope of the disclosure, which is possible with the judgment of those skilled in the technical field to which embodiments of the disclosure belong.

In an embodiment, the electronic device 101 may selectively use reader/writer mode, peer to peer (P2P) mode, and/or card emulation mode through the NFC circuit 308. In an embodiment, when the electronic device 101 operates the NFC circuit 308 in card emulation mode, the electronic device 101 may operate as a smart card providing functions such as payment, transit card, mobile ticket, membership, and/or access control, and may communicate with the NFC reader 320 using the NFC circuit 308.

In an embodiment, the electronic device 101 may further include an application processor (AP) 300, a communication processor (CP) 304, a global positioning system (GPS) module 306, and/or a SIM 310. In an embodiment, the application processor 300 and the communication processor 304 may correspond to the processor 120 of FIG. 1. In an embodiment, the GPS module 306 and the NFC circuit 308 may correspond to the wireless communication module 192 of FIG. 1. In an embodiment, the SIM 310 may correspond to the SIM 202 and/or the eSIM 204 of FIG. 2.

In an embodiment, the application processor 300 may be composed of one or more processors including processing circuitry. In an embodiment, the application processor 300 may include an NFC configuration management module 302 that manages an NFC configuration necessary for the NFC circuit 308 to operate. In an embodiment, the NFC configuration management module 302 may interwork with the communication processor 304, the GPS module 306, the NFC circuit 308, and/or the SIM 310 to determine or change an NFC configuration for the NFC circuit 308, and apply the NFC configuration to the NFC circuit 308 to cause the NFC circuit 308 to perform NFC operations using the NFC configuration. In an embodiment, the NFC configuration management module 302 may be a software module (e.g., an application) executed by the application processor 300, or may be a module that operates independently of the application processor 300.

In an embodiment, the NFC circuit 308 may communicate with the application processor 300 (e.g., the NFC configuration management module 302) and/or the SIM 310, and may perform overall operations related to NFC (e.g., NFC operations). In an embodiment, the NFC circuit 308 may include an NFC controller and an NFC transceiver. In an embodiment, the NFC circuit 308 may be implemented as portion of the wireless communication module 192 of FIG. 1, or may be included in the communication module 190 of FIG. 1.

In an embodiment, the NFC circuit 308 may be connected to an antenna (e.g., an NFC antenna 308a) configured to transmit signals according to NFC operations or receive signals from an external electronic device (e.g., the NFC reader 320). In an embodiment, the NFC antenna 308a may be implemented as portion of the antenna module 197 of FIG. 1, or may be included in the antenna module 197 of FIG. 1. In an embodiment, the NFC circuit 308 may communicate with the NFC reader 320 based on an NFC configuration determined by the application processor 300 (e.g., the NFC configuration management module 302).

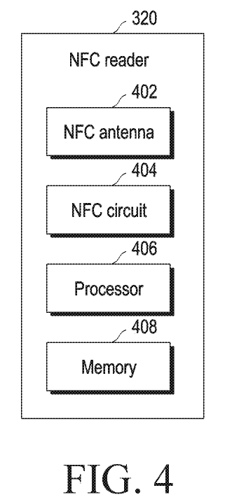

FIG. 4 is a block view illustrating a configuration of an NFC reader according to an embodiment of the disclosure.

Referring to FIG. 4, the NFC reader 320 may include an NFC antenna 402, an NFC circuit 404, a processor 406, and/or memory 408.

In an embodiment, the NFC circuit 404 may be connected to at least one antenna (e.g., the NFC antenna 402) configured to transmit signals according to NFC operations to an external electronic device (e.g., the electronic device 101 of FIG. 1) or receive signals according to NFC operations from an external electronic device (e.g., the electronic device 101 of FIG. 1). In an embodiment, the NFC circuit 404 may safely process the signals to provide NFC capabilities such as mobile payment, transit card, or ticket/membership identification required by the electronic device 101.

In an embodiment, the NFC circuit 404 may be controlled by a processor 406, which may be composed of one or more processors including processing circuitry, and may perform overall operations related to NFC (e.g., NFC operations). In an embodiment, the memory 408 may store instructions that, when executed by the processor 406, cause the NFC reader 320 to perform NFC operations. In an embodiment, the processor 406 may cause the NFC circuit 404 to process wireless signals based on one or more designated NFC protocols, based on the instructions stored in the memory 408.

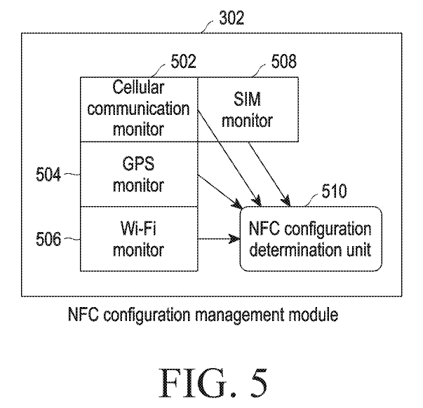

FIG. 5 is a view illustrating NFC configuration management according to an embodiment of the disclosure.

Referring to FIG. 5, an NFC configuration management module (e.g., the NFC configuration management module 302 of FIG. 3) of an electronic device (e.g., the electronic device 101 of FIG. 1) may determine an NFC technology configuration (hereinafter referred to as an NFC configuration) for providing card emulation services such as payment, transit card, mobile ticket, membership, and/or access control using the electronic device 101. In an embodiment, the NFC configuration may include parameters used in NFC operations by an NFC circuit (e.g., the NFC circuit 308 of FIG. 3), information indicating the type of NFC protocol used to process messages or signals for NFC operations, and/or routing information for routing the messages or signals to an NFC execution environment (NFCEE) (e.g., a default route indicating the NFCEE type of a destination to which commands are to be delivered).

In an embodiment, the NFC configuration management module 302 may determine an NFC configuration for the NFC circuit 308 based on location information related to the current location of the electronic device 101 and information related to a SIM (e.g., the SIM 310 of FIG. 3) inserted or embedded in the electronic device 101 (e.g., compatibility such as supported countries or supported protocol types).

In an embodiment, the NFC configuration management module 302 may include at least one of a cellular communication monitor 502, a GPS monitor 504, or a Wi-Fi monitor 506 for obtaining the location information. The cellular communication monitor 502 may estimate the current location of the electronic device 101 based on information (e.g., a public land mobile network (PLMN) ID or a mobile country code (MCC)) that the electronic device 101 obtains from a cellular communication network (e.g., the second network 199 of FIG. 1) through a communication processor (e.g., the communication processor 304 of FIG. 3). The GPS monitor 504 may calculate the current location of the electronic device 101 based on latitude and longitude calculated from signals received from satellites through a GPS module (e.g., the GPS module 306 of FIG. 3). The Wi-Fi monitor 506 may estimate the current location of the electronic device 101 based on information (e.g., access point (AP) information) obtained from a Wi-Fi network (e.g., the first network 198 of FIG. 1) through a communication processor (e.g., the communication processor 304 of FIG. 3). In an embodiment, the current location may be a city or country, but is not limited thereto, and may be represented in various forms such as a state, a geographical area, or an area including multiple countries.

In an embodiment, the NFC configuration management module 302 may include a SIM monitor 508 that may read information stored in the SIM 310 of the electronic device 101. In an embodiment, the SIM monitor 508 may communicate with the SIM 310 that is inserted or embedded in the electronic device 101 and activated. In an embodiment, the SIM monitor 508 may obtain information indicating whether the SIM 310 includes an NFC execution environment (NFCEE) module (e.g., a secure element (SE)) that stores and executes information related to NFC operations and information indicating NFC protocol(s) that may be supported by the NFCEE module of the SIM 310.

In an embodiment, the NFC configuration management module 302 may include an NFC configuration determination unit 510 that determines an NFC configuration for NFC operations based on location information obtained by at least one of the cellular communication monitor 502, the GPS monitor 504, or the Wi-Fi monitor 506, and/or SIM-related information obtained from the SIM monitor 508. In an embodiment, an NFC configuration may indicate protocol type(s) and/or NFCEE used in NFC operations.

In an embodiment, the NFC circuit 308 of the electronic device 101 may support at least one of various NFC protocols for NFC connection to an external electronic device (e.g., the NFC reader 320 of FIG. 3). In an embodiment, the NFC protocols may support NFC digital protocol technical specification, 14443 standards (e.g., 14443 type A and 14443 type B) defined by the International Organization for Standardization (ISO)/International Electrotechnical Commission (IEC), and/or ISO/IEC 18092 based on Japanese Industrial Standard (JIS) X 6319-4 (e.g., type F (Felica)). In embodiments of the disclosure, the standards may be simply referred to as NFC protocol type A, type B, and type F, respectively. In an embodiment, the NFC configuration may indicate at least one NFC protocol type to be used by the NFC circuit 308 to perform NFC operations.

In an embodiment, the NFC circuit 308 may communicate with the NFCEE module for security of NFC operations. In an embodiment, the NFCEE module may be a secure element (SE) that safely (e.g., by encryption) stores information used in NFC operations (e.g., payment applications, card emulation applications, ticketing applications, and/or membership applications) and provides processing capability for execution of the information. In an embodiment, the NFCEE module may provide security functions such as authentication and authorization. As an example, when contacting the electronic device 101 to the NFC reader 320 for payment service, the NFCEE module may safely encrypt payment data, personal information, and/or authentication information transmitted to or received from the NFC reader 320 through the NFC circuit 308. In an embodiment, the NFCEE module may be a hardware module, a software module, or a combination thereof.

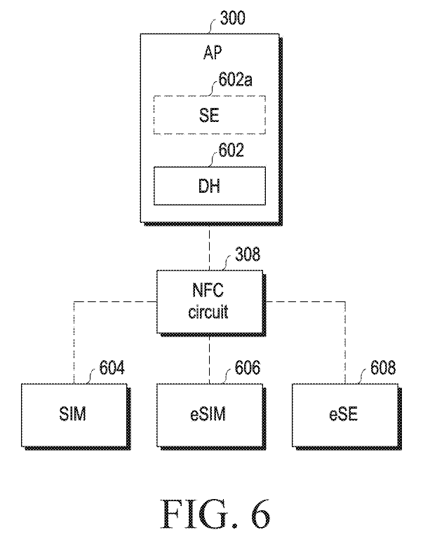

FIG. 6 is a view illustrating various NFC execution environments according to an embodiment of the disclosure.

Referring to FIG. 6, the NFC circuit 308 of the electronic device 101 may communicate with one or more NFCEE modules that may have various NFCEE types. In an embodiment, the NFCEE types may include at least one of a SIM type, an eSE type, an external storage type, or a device host (DH) type.

In an embodiment, at least one of the plurality of NFCEE modules may be implemented as at least one of a secure element (SE) 602a included in an application processor (e.g., the application processor 300 of FIG. 3) of the electronic device 101, a SIM 604 (e.g., the SIM 202 of FIG. 2) configured as a physical card, an eSIM 606 (e.g., the eSIM 204 of FIG. 2) configured as an embedded chip or software, or an embedded SE (eSE) 608, according to the corresponding NFCEE type. When the application processor 300 includes an NFC-related application (e.g., the SE 602a), the SE 602a may be connected to the NFC circuit 308 through a device host (DH) 602, and the device host 602 and/or the SE 602a may operate as the NFCEE module. Although not illustrated, the NFCEE module may also be implemented as an SE included in external storage (e.g., a MicroSD (secure digital) card).

In an embodiment, the NFC circuit 308 may communicate with an external electronic device (e.g., the NFC reader 320) through the NFCEE module (e.g., at least one of the device host 602, the SIM 604, the eSIM 606, or the eSE 608).

In an embodiment, an NFC protocol used by the NFC circuit 308 may be determined according to the type of NFCEE module (e.g., at least one of the DH 602, the SIM 604, the eSIM 606, or the eSE 608). As an example, when the DH 602 and/or the eSE 608 are used as NFCEE modules, the DH 602 and/or the eSE 608 each may support NFC protocol type A, type B, and type F. As an example, when the eSIM 606 is used as the NFCEE module, the eSIM 606 may support NFC protocol type A and type B (e.g., referred to as type A/B). As an example, when the SIM 604 is used as the NFCEE module, the SIM 604 may be configured to support only type A, support only type B, support type A and type B (e.g., referred to as type A/B), support type A and type F (e.g., referred to as type A/F), support type B and type F (e.g., referred to as type B/F), or support all of type A, type B, and type F (e.g., referred to as type A/B/F), according to design, manufacturer, or communication service provider.

In an embodiment, each of the NFC protocol types (e.g., NFC protocol type A, type B, and type F) requires an NFC configuration such as unique numbers, communication speeds, and other parameters necessary for NFC connection, and the NFC configuration may be determined for each NFCEE module (e.g., at least one of the DH 602, the SIM 604, the eSIM 606, or the eSE 608). In an embodiment, when a default route related to NFC protocol type A/B/F is a SIM type (e.g., the SIM 604), the NFC circuit 308 may perform NFC operations using unique numbers and communication speeds supported by the SIM 604. In an embodiment, when a default route related to NFC protocol type A/B/F is an eSE type (e.g., the eSE 608), the NFC circuit 308 may perform NFC operations using unique numbers and communication speeds supported by the eSE 608. In an embodiment, the electronic device 101 may designate an NFCEE type to communicate with the NFC circuit 308 according to an NFC protocol type.

In an embodiment, the electronic device 101 (e.g., the application processor 300) may execute a mobile payment application, select a card service through an operation of selecting and authenticating a credit card that the user wants to use through the mobile payment application, determine an NFCEE module (e.g., at least one of the device host 602, the SIM 604, the eSIM 606, or the eSE 608) appropriate for providing the card service and an NFC protocol type to be used for NFC operations (e.g., listen discovery), and notify the NFC circuit 308 to communicate with an external electronic device (e.g., a card reader for payment service) using the determined NFCEE module and NFC protocol type. In an embodiment, the electronic device 101 may determine a predetermined NFCEE module (e.g., at least one of the device host 602, the SIM 604, the eSIM 606, or the eSE 608) and an NFC protocol type to be used for NFC operations (e.g., listen discovery) at the start of a transit card service, and notify the NFC circuit 308 to communicate with an external electronic device (e.g., a card reader for transit card service) using the determined NFCEE module and NFC protocol type.

In an embodiment, when the default route is set to a SIM (e.g., the SIM 604), supported NFC protocol types may be limited according to the NFC capability of the SIM 604. For example, a SIM chip sold in Korea may support only type A and may not have the capability to perform type B NFC operations. For example, some SIM chips sold in Hong Kong may support only type F and may not have the capability to perform type B NFC operations. In an embodiment, when the electronic device 101 is required to support type B NFC operations, a default route may need to be designated to the NFCEE module other than the SIM (e.g., the device host 602 or the eSE 608).

Preferred services and protocols for NFC operations may vary according to areas (e.g., cities, countries, or country groups including multiple countries), and accordingly, the electronic device 101 may be fixed to use the NFCEE module and NFC configuration corresponding to a country designated for the electronic device 101 at the time of manufacture (hereinafter referred to as a default country).

For example, when the target country for sale of the electronic device 101 is Korea, at the time of manufacturing the electronic device 101, the default route for type A/B/F may be set to SIM, and the NFC protocol for listen discovery may be designated as type A. For example, when the target country for sale of the electronic device 101 is France, at the time of manufacturing the electronic device 101, the default route for type A/B/F may be set to SIM, and the NFC protocol for listen discovery may be designated as type B. For example, when the target country for sale of the electronic device 101 is Japan, at the time of manufacturing the electronic device 101, the default route for type A/B/F may be set to eSE, and the NFC protocol for listen discovery may be designated as type F.

The user may want to use a transit card service in Japan with the electronic device 101 purchased in Korea, but since the default route of the electronic device 101 is not eSE, the user may not use the electronic device 101 as a transit card to use transportation in Japan. Meanwhile, since the NFC protocol for listen discovery of the electronic device 101 purchased in Korea is type A, the user may not use the electronic device 101 as a transit card in France, which designates NFC protocol type B for listen discovery.

Embodiments of the disclosure may determine an NFC configuration suitable for a current location. In an embodiment, the electronic device 101 may dynamically determine an NFC configuration according to the current location (e.g., country) of the electronic device 101 and available NFCEE conditions. In an embodiment, the electronic device 101 may receive a request for a location and desired NFC configuration for a specific service (e.g., card service) through an application using NFC (e.g., a mobile payment application), and determine an NFC configuration based on the request. In an embodiment, the electronic device 101 may dynamically determine an NFC configuration by utilizing location information obtained through the cellular communication monitor 502, the GPS monitor 504, and/or the Wi-Fi monitor 506. In an embodiment, the electronic device 101 may determine an NFC configuration by considering compatibility (e.g., supportable NFC protocol types and/or mobile country code (MCC)) with a SIM (e.g., the SIM 310) inserted (e.g., embedded) and activated in the electronic device 101, so that the NFC circuit 308 may more smoothly handle NFC connections with external electronic devices (e.g., the NFC reader 320).

In an embodiment, the NFC configuration may include at least one of information indicating an area (e.g., a city, country, or country group including at least one country) to which the NFC configuration is applicable, NFC protocol type(s) to be used to perform listen discovery among NFC operations, information indicating whether NFCEE of a SIM type is supported, information indicating at least one supportable NFCEE type, or routing information indicating an NFCEE type (e.g., device host, eSE, or SIM) of a destination (e.g., default route) to which commands received from an external electronic device (e.g., the NFC reader 320) are to be delivered. In an embodiment, the default route may indicate at least one NFCEE type corresponding to a type of command.

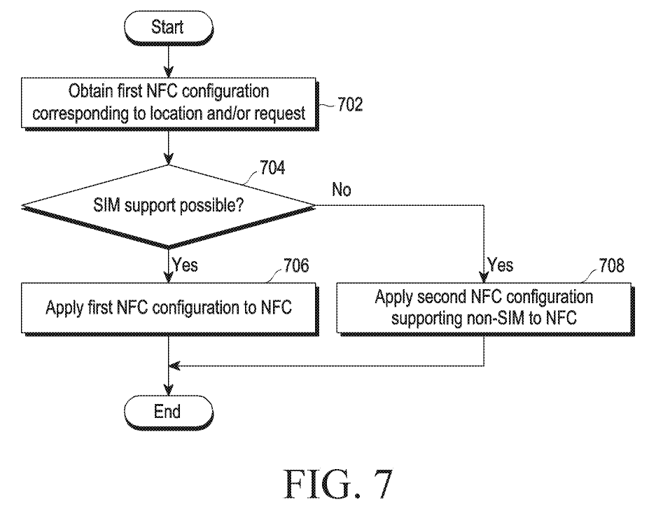

FIG. 7 is a flowchart illustrating determining an NFC configuration according to an embodiment of the disclosure. At least one of the operations described below may be executed by a processor (e.g., the processor 120 of FIG. 1 or the application processor 300 of FIG. 3) of the electronic device 101. In an embodiment, memory (e.g., the memory 130 of FIG. 1) of the electronic device 101 may store instructions that, when executed individually or collectively by the processor 120, cause the electronic device 101 to perform at least one of the operations described below. At least one of the operations described below may be omitted, modified, or executed in a different order according to embodiments.

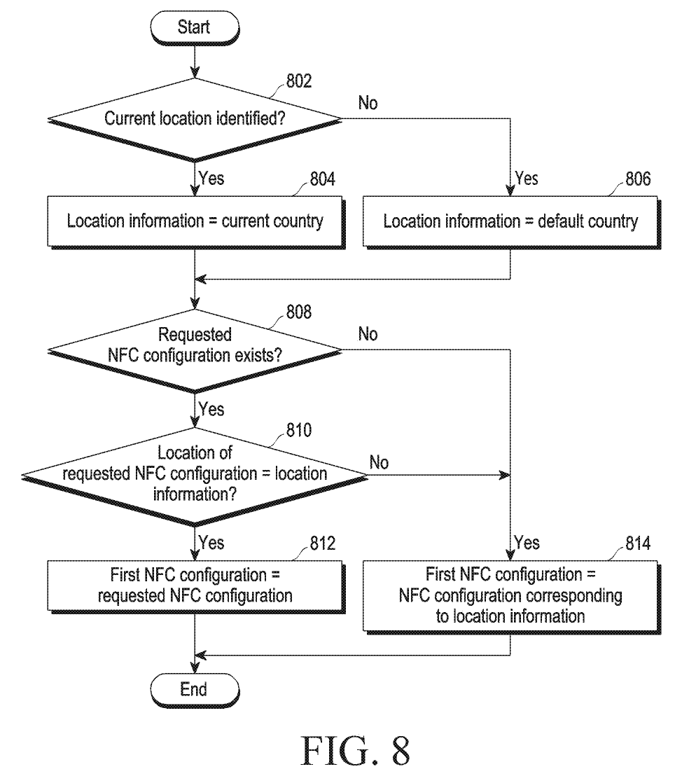

Referring to FIG. 7, in operation 702, the electronic device 101 (e.g., the processor 120) may obtain a first NFC configuration corresponding to a current location of the electronic device 101 and/or a request from an application for using NFC (e.g., a mobile payment application or a transit card application). In an embodiment, operation 702 may include at least one of the operations of FIG. 8.

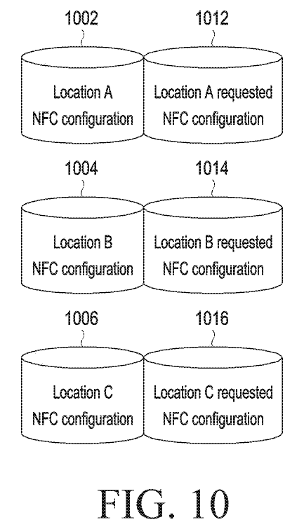

In an embodiment, the electronic device 101 (e.g., the processor 120) may determine an NFC configuration corresponding to a default country set at the time of manufacturing the electronic device 101, a country setting set by the user, or a country to which the current location of the electronic device 101 belongs as the first NFC configuration. In an embodiment, the electronic device 101 may store a plurality of NFC configurations (e.g., the NFC configurations 1002, 1004, 1006 of FIG. 10) corresponding to a plurality of countries or a plurality of areas in memory (e.g., the memory 130 of FIG. 1), and read one NFC configuration corresponding to a default country, country setting, or current location from among the plurality of NFC configurations from the memory to determine it as the first NFC configuration.

In an embodiment, the electronic device 101 (e.g., the processor 120) may determine a requested NFC configuration for an application as the first NFC configuration based on execution of an application for using NFC.

In an embodiment, the electronic device 101 may store the determined first NFC configuration in memory (e.g., the memory 130 of FIG. 1) as a requested NFC configuration corresponding to the current location of the electronic device 101. In an embodiment, the electronic device 101 may store a plurality of requested NFC configurations (e.g., the NFC configurations 1012, 1014, 1016) corresponding to a plurality of locations (e.g., location A, location B, and location C) in memory (e.g., the memory 130 of FIG. 1).

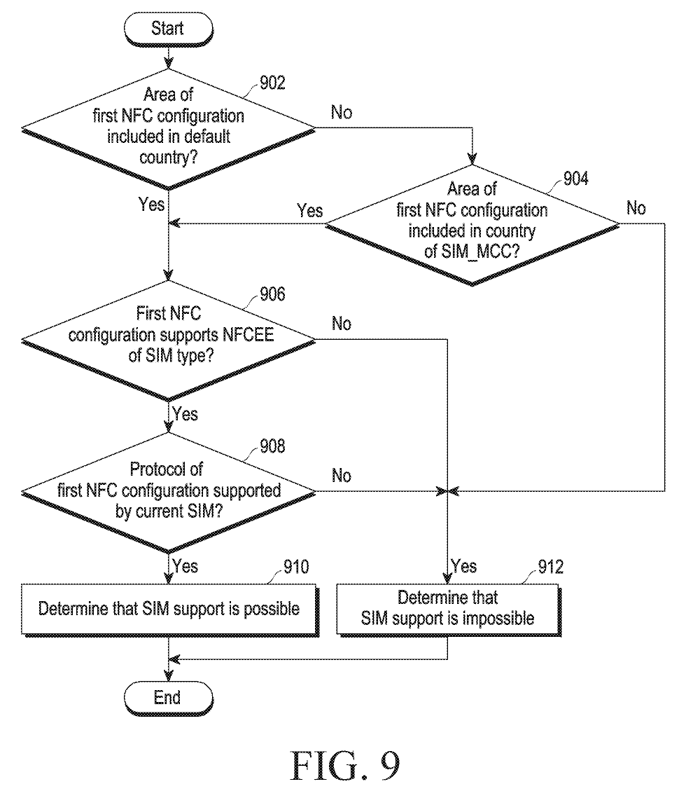

In operation 704, the electronic device 101 (e.g., the processor 120) may determine whether the first NFC configuration is supportable by a SIM (e.g., the SIM 310 of FIG. 3) of the electronic device 101. In an embodiment, operation 704 may include at least one of the operations of FIG. 9.

In an embodiment, the electronic device 101 (e.g., the processor 120) may determine that the first NFC configuration may be supported by the SIM 310 when the first NFC configuration supports the NFCEE module of a SIM type. In an embodiment, the electronic device 101 (e.g., the processor 120) may determine that the first NFC configuration may be supported by the SIM 310 when an area of the first NFC configuration and supportable NFC protocol types included in the first NFC configuration are supported by the SIM 310.

In an embodiment, when the first NFC configuration is supportable by the SIM 310, the electronic device 101 (e.g., the processor 120) may proceed to operation 706. In an embodiment, when the first NFC configuration is not supportable by the SIM 310, the electronic device 101 (e.g., the processor 120) may proceed to operation 708.

In operation 706, the electronic device 101 (e.g., the processor 120) may notify the first NFC configuration to an NFC circuit (e.g., the NFC circuit 308 of FIG. 3) to cause the NFC circuit 308 to perform NFC operations based on the first NFC configuration.

In operation 708, the electronic device 101 (e.g., the processor 120) may obtain a second NFC configuration supporting NFCEE of a non-SIM type instead of the first NFC configuration and notify the second NFC configuration to an NFC circuit (e.g., the NFC circuit 308 of FIG. 3) to cause the NFC circuit 308 to perform NFC operations based on the second NFC configuration. In an embodiment, the electronic device 101 (e.g., the processor 120) may determine an NFC configuration supporting NFCEE of a non-SIM type (e.g., the device host 602 or the eSE 608) among at least one NFC configuration corresponding to an area (e.g., a country group) including the current location of the electronic device 101 as the second NFC configuration. In an embodiment, the electronic device 101 (e.g., the processor 120) may obtain the second NFC configuration from memory (e.g., the memory 130 of FIG. 3).

In an embodiment, the electronic device 101 (e.g., the processor 120) may start the procedure of FIG. 7 based on identifying that functions and/or information related to NFC configuration is changed. In an embodiment, the electronic device 101 (e.g., the processor 120) may start the procedure of FIG. 7 based on the electronic device 101 being powered on, airplane mode being changed (e.g., activated or deactivated), an NFC feature being activated, a SIM (e.g., the SIM 310 of FIG. 3) being recognized (or activated) or removed (or deactivated), or location information of the electronic device 101 being changed (e.g., moved to another country). Further, based on an NFC-related application (e.g., a mobile payment application or a wallet application) requesting an area change or NFC configuration for a specific service (e.g., card service), the electronic device 101 (e.g., the processor 120) may start the procedure of FIG. 7.

FIG. 8 is a flowchart illustrating determining a first NFC configuration according to an embodiment of the disclosure. At least one of the operations described below may be executed by a processor (e.g., the processor 120 of FIG. 1 or the application processor 300 of FIG. 3) of the electronic device 101. In an embodiment, memory (e.g., the memory 130 of FIG. 1) of the electronic device 101 may store instructions that, when executed individually or collectively by the processor 120, cause the electronic device 101 to perform at least one of the operations described below. At least one of the operations described below may be omitted, modified, or executed in a different order according to embodiments.

Referring to FIG. 8, in operation 802, the electronic device 101 (e.g., the processor 120) may determine whether the current location of the electronic device 101 is identifiable. In an embodiment, the electronic device 101 (e.g., the processor 120) may determine that the current location is identifiable based on obtaining location information (e.g., PLMN ID or MCC) of a cellular communication network from the communication processor 304 through the cellular communication monitor 502. In an embodiment, the electronic device 101 (e.g., the processor 120) may determine that the current location is identifiable based on obtaining location information (e.g., latitude and longitude) from GPS satellites through the GPS monitor 504. In an embodiment, the electronic device 101 (e.g., the processor 120) may determine that the current location is identifiable based on obtaining location information (e.g., AP information) from a Wi-Fi network through the Wi-Fi monitor 506. When the current location is identifiable, the electronic device 101 (e.g., the processor 120) may proceed to operation 804. When the current location is not identifiable, or when the current location is the same as a default country, the electronic device 101 (e.g., the processor 120) may proceed to operation 806.

In operation 804, the electronic device 101 (e.g., the processor 120) may determine location information of the electronic device 101 as a country (e.g., current country) to which the current location belongs. In an embodiment, the electronic device 101 (e.g., the processor 120) may determine location information of the electronic device 101 as a country (e.g., current country) to which the current location belongs, based on identifying that the current location is identified and the current location is not included in a default country of the electronic device 101.

In operation 806, the electronic device 101 (e.g., the processor 120) may determine location information of the electronic device 101 as a default country of the electronic device 101.

In operation 808, the electronic device 101 (e.g., the processor 120) may determine whether an NFC configuration (e.g., requested NFC configuration) required for an NFC-related application or a service using NFC is present. In an embodiment, the electronic device 101 (e.g., the processor 120) may receive information indicating a requested NFC configuration (e.g., NFC protocol type or NFCEE type) from a payment application using NFC feature. When a requested NFC configuration for the application or service is present, the electronic device 101 (e.g., the processor 120) may proceed to operation 810. When a requested NFC configuration for the application or service is not present, the electronic device 101 (e.g., the processor 120) may proceed to operation 814.

In operation 810, the electronic device 101 (e.g., the processor 120) may determine whether a location corresponding to the requested NFC configuration for the application or service is the same as location information of the electronic device 101 (e.g., location information determined in operation 804 or operation 806). In an embodiment, the electronic device 101 (e.g., the processor 120) may receive information indicating a location for applying the requested NFC configuration along with the requested NFC configuration from a payment application. In an embodiment, the location may indicate a city, country, or area. The electronic device 101 (e.g., the processor 120) may determine that a location corresponding to the requested NFC configuration is the same as the location information when the location corresponding to the requested NFC configuration is included in a country indicated by the location information, and may proceed to operation 812. When the location corresponding to the requested NFC configuration is not included in a country indicated by the location information, the electronic device 101 (e.g., the processor 120) may determine that the location corresponding to the requested NFC configuration is not the same as the location information and may proceed to operation 814.

In operation 812, the electronic device 101 (e.g., the processor 120) may determine the requested NFC configuration as a first NFC configuration (e.g., the first NFC configuration of operation 702). In an embodiment, the electronic device 101 (e.g., the processor 120) may determine to use the requested NFC configuration when a requested NFC configuration related to an NFC-related application or service is present and the location corresponding to the requested NFC configuration is included in a current country or default country.

In operation 814, the electronic device 101 (e.g., the processor 120) may determine an NFC configuration corresponding to the location information of the electronic device 101 (e.g., location information determined in operation 804 or operation 806) as a first NFC configuration (e.g., the first NFC configuration of operation 702). In an embodiment, the electronic device 101 (e.g., the processor 120) may determine to use an NFC configuration corresponding to the location information instead of the requested NFC configuration when a requested NFC configuration related to an NFC-related application or service is not present and the location corresponding to the requested NFC configuration is not included in a current country or default country. In an embodiment, the electronic device 101 (e.g., the processor 120) may read an NFC configuration corresponding to the location information from among a plurality of NFC configurations (e.g., the NFC configurations 1002, 1004, 1006 of FIG. 10) stored in memory (e.g., the memory 130).

In an embodiment, operations 808, 810, and 812 may be omitted, and the electronic device 101 (e.g., the processor 120) may determine an NFC configuration corresponding to the location information of the electronic device 101 as the first NFC configuration. In an embodiment, operations 802 to 812 may be omitted, and an NFC configuration corresponding to a current location may be determined as the first NFC configuration based on identifying that the current location of the electronic device 101 is not included in a default country of the electronic device 101.

FIG. 9 is a flowchart illustrating determining SIM compatibility of an NFC configuration according to an embodiment of the disclosure. At least one of the operations described below may be executed by a processor (e.g., the processor 120 of FIG. 1 or the application processor 300 of FIG. 3) of the electronic device 101. In an embodiment, memory (e.g., the memory 130 of FIG. 1) of the electronic device 101 may store instructions that, when executed individually or collectively by the processor 120, cause the electronic device 101 to perform at least one of the operations described below. At least one of the operations described below may be omitted, modified, or executed in a different order according to embodiments.

Referring to FIG. 9, in operation 902, the electronic device 101 (e.g., the processor 120) may determine whether an area corresponding to a first NFC configuration (e.g., the first NFC configuration of operation 702) includes a default country of the electronic device 101. In an embodiment, when a first NFC configuration is determined based on location information of the electronic device 101 (e.g., operation 814 of FIG. 8), the electronic device 101 (e.g., the processor 120) may determine that an area (e.g., country or country group) including a location indicated by the location information corresponds to the first NFC configuration. In an embodiment, when the first NFC configuration corresponds to a requested NFC configuration for an NFC-related application or service, the electronic device 101 (e.g., the processor 120) may determine that an area (e.g., country or country group) corresponding to the requested NFC configuration corresponds to the first NFC configuration.

When the area of the first NFC configuration does not include the default country, the electronic device 101 (e.g., the processor 120) may proceed to operation 904. When the area of the first NFC configuration includes the default country, the electronic device 101 (e.g., the processor 120) may proceed to operation 906.

In operation 904, the electronic device 101 (e.g., the processor 120) may determine whether the area of the first NFC configuration is included in a country corresponding to a SIM (e.g., the SIM 310 of FIG. 3) currently installed (or activated) in the electronic device 101. In an embodiment, the electronic device 101 (e.g., the processor 120) may obtain MCC information (e.g., SIM_MCC) indicating an area (e.g., country) where the SIM 310 is usable from the SIM 310 through a SIM monitor (e.g., the SIM monitor 508 of FIG. 5), and determine whether an area of the NFC configuration includes an area indicated by the SIM_MCC.

When the area of the first NFC configuration includes an area indicated by the SIM_MCC, the electronic device 101 (e.g., the processor 120) may proceed to operation 906. When the area of the first NFC configuration does not include an area indicated by the SIM_MCC, the electronic device 101 (e.g., the processor 120) may proceed to operation 912. In an embodiment, operation 904 may be omitted, and the electronic device 101 (e.g., the processor 120) may proceed to operation 912 based on determining "No" in operation 902.

In operation 906, the electronic device 101 (e.g., the processor 120) may determine whether the first NFC configuration supports NFCEE of a SIM type, based on the first NFC configuration. In an embodiment, when the first NFC configuration includes information indicating that it supports NFCEE of a SIM type, the electronic device 101 (e.g., the processor 120) may proceed to operation 908. In an embodiment, when the first NFC configuration does not include information indicating that it supports NFCEE of a SIM type (e.g., when it includes information indicating that it supports NFCEE of a non-SIM type (e.g., the device host 602 or the eSE 608)), the electronic device 101 (e.g., the processor 120) may proceed to operation 912.

In operation 908, the electronic device 101 (e.g., the processor 120) may determine whether the SIM 310 supports NFC protocol type(s) of the first NFC configuration. In an embodiment, the electronic device 101 (e.g., the processor 120) may obtain information about at least one NFC protocol type supported by the SIM 310 through a SIM monitor (e.g., the SIM monitor 508 of FIG. 5). In an embodiment, the electronic device 101 (e.g., the processor 120) may determine that the SIM 310 supports NFC protocol type(s) of the first NFC configuration when NFC protocol type(s) of the first NFC configuration include the NFC protocol type supported by the SIM 310. When it is determined that the SIM 310 supports NFC protocol type(s) of the first NFC configuration, the electronic device 101 (e.g., the processor 120) may proceed to operation 910. When it is determined that the SIM 310 does not support NFC protocol type(s) of the first NFC configuration, the electronic device 101 (e.g., the processor 120) may proceed to operation 912.

In operation 910, the electronic device 101 (e.g., the processor 120) may determine that the first NFC configuration is supportable by the SIM 310. The electronic device 101 (e.g., the processor 120) may proceed to operation 706 of FIG. 7 based on determining that the first NFC configuration is supported by the SIM 310.

In operation 912, the electronic device 101 (e.g., the processor 120) may determine that the first NFC configuration is not supported by the SIM 310. The electronic device 101 (e.g., the processor 120) may proceed to operation 708 of FIG. 7 based on determining that the first NFC configuration is not supported by the SIM 310.

FIG. 10 illustrates a plurality of NFC configurations according to an embodiment of the disclosure.

Referring to FIG. 10, the electronic device 101 may store a plurality of NFC configurations (e.g., the NFC configurations 1002, 1004, 1006) respectively corresponding to a plurality of locations (e.g., location A, location B, and location C) in memory (e.g., the memory 130 of FIG. 1), and determine at least one NFC configuration corresponding to a current location of the electronic device 101 among the NFC configurations 1002, 1004, 1006 as a first NFC configuration. In an embodiment, each of the location A, location B, and location C may correspond to a city or country, or an area including multiple countries.

In an embodiment, the electronic device 101 may receive a requested NFC configuration from a service or application, and store the received requested NFC configuration in the memory 130 to correspond to a location (e.g., city, country, or area) requested from the service or application. In an embodiment, the electronic device 101 may store a plurality of requested NFC configurations (e.g., the requested NFC configurations 1012, 1014, 1016) respectively corresponding to a plurality of locations (e.g., location A, location B, and location C) in memory (e.g., the memory 130 of FIG. 1).

In an embodiment, when the electronic device 101 does not have location information indicating a current location (e.g., when the current location of the electronic device 101 may not be identified), the electronic device 101 may determine an NFC configuration of an area to which a default country (e.g., default country) determined at the time of manufacturing the electronic device 101 belongs as a first NFC configuration.

In an embodiment, when the electronic device 101 has location information indicating a current location (e.g., when the current location of the electronic device 101 may be identified) and an NFC configuration of an area including the current location (e.g., any one of the NFC configurations 1112, 1114, 1116, 1118, 1120) is stored in the memory 130, the electronic device 101 may determine an NFC configuration of an area including the current location as a first NFC configuration based on the absence of an NFC configuration requested from a service or application.

In an embodiment, when a first NFC configuration determined based on a default location or current location is not compatible with an NFC configuration (e.g., requested NFC configuration) required by a service (e.g., mobile payment, transit card, or membership) that the electronic device 101 wants to use through an NFC-related application, the electronic device 101 may determine a requested NFC configuration received from a service or application as a first NFC configuration based on the existence of a requested NFC configuration obtained from the service or application. In an embodiment, the electronic device 101 may determine the requested NFC configuration as a first NFC configuration when a location requested by an application (e.g., an area corresponding to the requested NFC configuration) includes a current location. In an embodiment, when a current location may not be identified, the electronic device 101 may determine the requested NFC configuration as a first NFC configuration based on a location requested by an application (e.g., an area corresponding to the requested NFC configuration) including a default location of the electronic device 101.

In an embodiment, the electronic device 101 may determine whether a first NFC configuration supports NFCEE of a SIM type in order to determine whether the first NFC configuration is compatible with a SIM 310 currently being used in the electronic device 101. In an embodiment, when a first NFC configuration does not support NFCEE of a SIM type, the electronic device 101 may determine that the first NFC configuration is not compatible with the SIM 310, and determine to use another NFC configuration (e.g., second NFC configuration) supporting NFCEE of a non-SIM type instead of the first NFC configuration.

In an embodiment, when a first NFC configuration supports NFCEE of a SIM type and NFC protocol type(s) of the first NFC configuration include the NFC protocol type supported by the SIM 310, the electronic device 101 may determine to use the first NFC configuration. In an embodiment, when a first NFC configuration supports NFCEE of a SIM type but NFC protocol type(s) of the first NFC configuration do not include the NFC protocol type supported by the SIM 310, the electronic device 101 may obtain another NFC configuration (e.g., second NFC configuration) supporting NFCEE of a non-SIM type from the memory 130 and apply it to the NFC circuit 308 instead of the first NFC configuration.

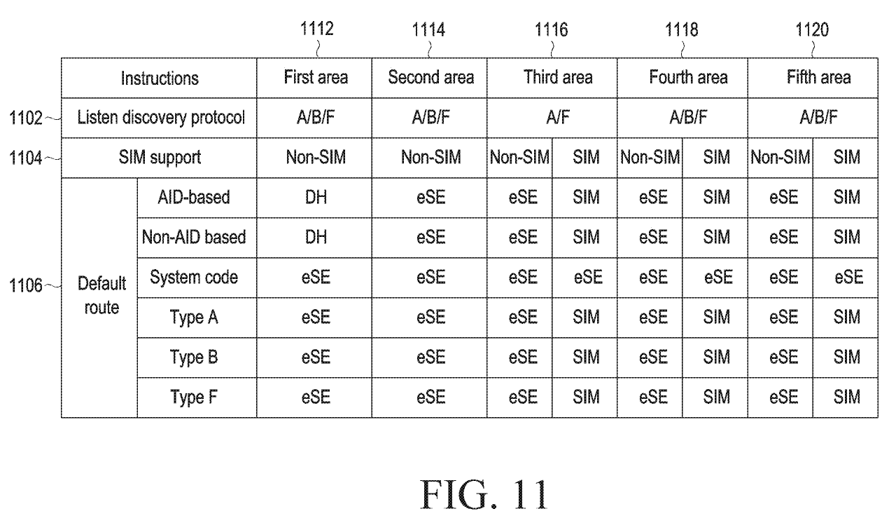

FIG. 11 illustrates regional NFC configurations according to an embodiment of the disclosure.

Referring to FIG. 11, the electronic device 101 may identify a plurality of areas (e.g., first area, second area, third area, fourth area, and fifth area) each including at least one country, and store NFC configurations 1112, 1114, 1116, 1118, 1120 respectively corresponding to the plurality of areas in memory (e.g., the memory 130 of FIG. 1). In an embodiment, each of the plurality of areas may include one or more countries. For example, a first area may include the United States (and its neighboring country(s)), a second area may include Japan, a third area may include Korea, a fourth area may include China (and its neighboring country(s)), and a fifth area may include Europe (and its neighboring country(s)). In an embodiment, the NFC configurations 1112, 1114, 1116, 1118, 1120 may be stored in the memory 130 by a manufacturer, server, or user of the electronic device 101.

In an embodiment, each of the NFC configurations 1112, 1114, 1116, 1118, 1120 may include at least one of listen discovery protocol information 1102 indicating the NFC protocol type to be used for listen discovery, information 1104 indicating whether NFCEE of a SIM type is supported, or default route information 1106 indicating an NFCEE type of a destination (e.g., default route) to which commands are to be delivered. In an embodiment, the default route information 1106 may include at least one of first information indicating an NFCEE type where application identification (AID)-based commands (e.g., commands including an AID indicating a destination application) are to be delivered, second information indicating an NFCEE type where non-AID-based commands (e.g., commands not including an AID) are to be delivered, third information indicating an NFCEE type where system code commands are to be delivered, fourth information indicating an NFCEE type where commands of NFC protocol type A are to be delivered, fifth information indicating an NFCEE type where commands of NFC protocol type B are to be delivered, or sixth information indicating an NFCEE type where commands of NFC protocol type F are to be delivered.

In an embodiment, an NFC configuration 1112 corresponding to a first area may support listen discovery protocol A/B/F, support NFCEE of a non-SIM type, have the default route for AID-based commands and non-AID-based commands as NFCEE of a DH type, and have the default route for system code and commands of NFC protocol type A/B/F as NFCEE of an eSE type. In an embodiment, an NFC configuration 1114 corresponding to a second area may support listen discovery protocol A/B/F, support NFCEE of a non-SIM type, and have the default route for AID-based commands, non-AID-based commands, system code, and commands of NFC protocol type A/B/F as NFCEE of an eSE type.

In an embodiment, an NFC configuration 1116 corresponding to a third area may support listen discovery protocol A/F and may support both NFCEE of a non-SIM type and NFCEE of a SIM type. When NFCEE of a non-SIM type is used, in the NFC configuration 1116 corresponding to the third area, the default route for AID-based commands, non-AID-based commands, system code, and commands of NFC protocol type A/B/F may be NFCEE of an eSE type. When NFCEE of a SIM type is used, in the NFC configuration 1116 corresponding to the third area, the default route for AID-based commands, non-AID-based commands, and commands of NFC protocol type A/B/F may be NFCEE of a SIM type, and the default route for system code commands may be NFCEE of an eSE type.

In an embodiment, an NFC configuration 1118 corresponding to a fourth area may support listen discovery protocol A/B/F and may support both NFCEE of a non-SIM type and NFCEE of a SIM type. When NFCEE of a non-SIM type is used, in the NFC configuration 1118 corresponding to the fourth area, the default route for AID-based commands, non-AID-based commands, system code, and commands of NFC protocol type A/B/F may be NFCEE of an eSE type. When NFCEE of a SIM type is used, in the NFC configuration 1118 corresponding to the fourth area, the default route for AID-based commands, non-AID-based commands, and commands of NFC protocol type A/B/F may be NFCEE of a SIM type, and the default route for system code commands may be NFCEE of an eSE type.

In an embodiment, an NFC configuration 1120 corresponding to a fifth area may support listen discovery protocol A/B/F and may support both NFCEE of a non-SIM type and NFCEE of a SIM type. When NFCEE of a non-SIM type is used, in the NFC configuration 1120 corresponding to the fifth area, the default route for AID-based commands, non-AID-based commands, system code, and commands of NFC protocol type A/B/F may be NFCEE of an eSE type. When NFCEE of a SIM type is used, in the NFC configuration 1120 corresponding to the fifth area, the default route for AID-based commands, non-AID-based commands, and commands of NFC protocol type A/B/F may be NFCEE of a SIM type, and the default route for system code commands may be NFCEE of an eSE type.

In an embodiment, the electronic device 101 may need to use different NFC protocol types according to a country where the electronic device 101 is currently positioned and an external electronic device (e.g., the NFC reader 320 of FIG. 3) with which the electronic device 101 wants to communicate. In an embodiment, the electronic device 101 may set an NFCEE type to eSE and support NFC protocol type A/B/F. When an external electronic device supports NFC protocol type A/B and the electronic device 101 uses an NFC configuration including only NFC protocol type A as listen discovery protocol information 1102, the electronic device 101 may respond only to signals of NFC protocol type A among signals of NFC protocol type A and B received from the external electronic device. The electronic device 101 may secure compatibility with a country or external electronic device through the listen discovery protocol information 1102.

In an embodiment, the electronic device 101 may determine a destination (e.g., NFCEE type) to which commands received from an external electronic device (e.g., the NFC reader 320) are to be delivered, based on the default route information 1106. In an embodiment, when an external electronic device transmits an AID-based command (e.g., SELECT command) defined in ISO/IEC 7816-4, the electronic device 101 may deliver the AID-based command received through the NFC circuit 308 to the NFCEE module (e.g., at least one of the device host 602, the SIM 604, the eSIM 606, or the eSE 608) of an NFCEE type indicated by first information among the default route information 1106. In an embodiment, when a specific AID and NFCEE type are designated for an NFC-related application, the electronic device 101 may deliver a command having the specific AID to the NFCEE module of the designated NFCEE type.

In an embodiment, when an external electronic device transmits a non-AID-based command, the electronic device 101 may deliver the non-AID-based command received through the NFC circuit 308 to the NFCEE module of an NFCEE type indicated by second information among the default route information 1106. For example, when a non-AID-based transit card application is executed in the eSE 608, the electronic device 101 may use an NFC configuration in which second information for non-AID-based commands is designated as an eSE type for the transit card application. In an embodiment, commands according to system code or NFC protocol type A/B/F may be delivered to the NFCEE module indicated by corresponding default route information (e.g., third, fourth, fifth, sixth information).

In an embodiment, when the default route for NFC protocol type A/B/F is designated as a SIM type, the electronic device 101 may execute NFC operations through the SIM 310 when the NFC protocol type supported by a SIM (e.g., the SIM 310) being used in the electronic device 101 is compatible with NFC protocol type(s) indicated by the listen discovery protocol information 1102.

In an embodiment, when the SIM 310 supports only NFC protocol type A, even when the default route for non-AID-based commands is a SIM type and the default route for NFC protocol type A is a SIM type, if a listen discovery protocol is NFC protocol type B/F, the electronic device 101 discovers external electronic devices according to the listen discovery protocol, and therefore may not normally process commands received from the discovered external electronic devices through the SIM 310. To prevent this, the electronic device 101 may determine an NFC configuration based on compatibility between the NFC protocol type supported by the SIM 310 and a listen discovery protocol.

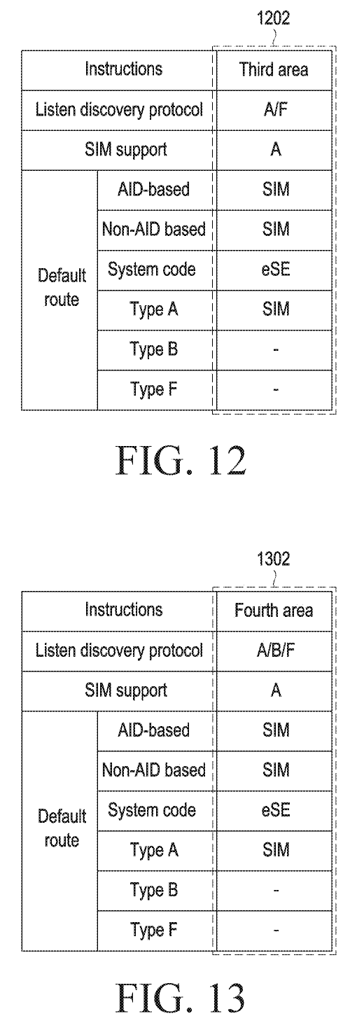

FIGS. 12, 13, 14, 15, 16, 17, 18, and 19 illustrate examples of NFC configurations according to various embodiments of the disclosure.

Referring to FIG. 12, a default country of the electronic device 101 is Korea and a SIM (e.g., the SIM 310 of FIG. 3) inserted in the electronic device 101 may support only NFC protocol type A. The electronic device 101 may perform NFC operations through the NFC circuit 308 according to an NFC configuration 1202 when positioned in Korea. In an embodiment, the NFC configuration 1202 may support listen discovery protocol A/F, support NFC protocol type A through NFCEE of a SIM type, and have the default route for AID-based commands, non-AID-based commands, and commands of NFC protocol type A as NFCEE of a SIM type and the default route for system code commands as NFCEE of an eSE type.

In an embodiment, when the electronic device 101 is positioned in Taiwan, a transit card service of Taiwan may use an eSE type as the default route for non-AID-based commands and use listen discovery protocol A. In an embodiment, although the SIM 310 of the electronic device 101 supports NFC protocol type A, since the transit card service of Taiwan does not support NFCEE of a SIM type, the electronic device 101 may not process non-AID-based commands in Taiwan.

Referring to FIG. 13, the electronic device 101 may determine the current location as Taiwan and determine an NFC configuration 1302 (e.g., an NFC configuration corresponding to a SIM type among the NFC configuration 1118 of FIG. 11) corresponding to a fourth area related to Taiwan as a first NFC configuration. In an embodiment, the NFC may support listen discovery protocol A/B/F, support NFC protocol type A through NFCEE of a SIM type, and have the default route for AID-based commands, non-AID-based commands, and commands of NFC protocol type A as NFCEE of a SIM type and the default route for system code commands as NFCEE of an eSE type.

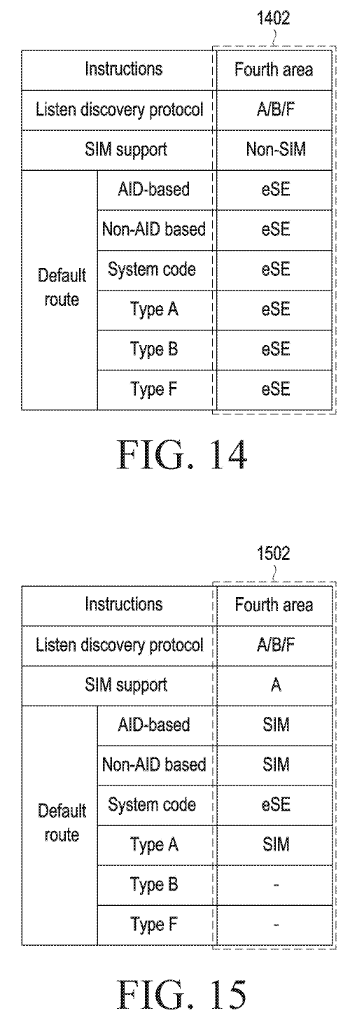

Referring to FIG. 14, the electronic device 101 may determine compatibility between the NFC configuration 1302 and the SIM 310. In an embodiment, since MCC information of the SIM 310 indicates Korea, the electronic device 101 may determine to apply an NFC configuration 1402 (e.g., an NFC configuration corresponding to a non-SIM type among the NFC configuration 1118 of FIG. 11) corresponding to the fourth area to the NFC circuit 308, based on the MCC information of the SIM 310 not matching an area of the NFC configuration 1302. Since the NFC configuration 1402 supports listen discovery protocol A/B/F and uses NFCEE of an eSE type as the default route for AID-based commands, non-AID-based commands, system code, and commands of NFC protocol type A/B/F, the electronic device 101 may use a transit card service of Taiwan through the NFC circuit 308 based on the NFC configuration 1402.

Referring to FIG. 15, the user may remove a Korean SIM from the electronic device 101 and insert a SIM 310 for use in Taiwan into the electronic device 101. In an embodiment, the electronic device 101 may determine an NFC configuration 1502 (an NFC configuration corresponding to a SIM type among the NFC configuration 1118) corresponding to a fourth area including Taiwan as a first NFC configuration, and identify that the NFC configuration 1502 is compatible with the SIM 310 for use in Taiwan.

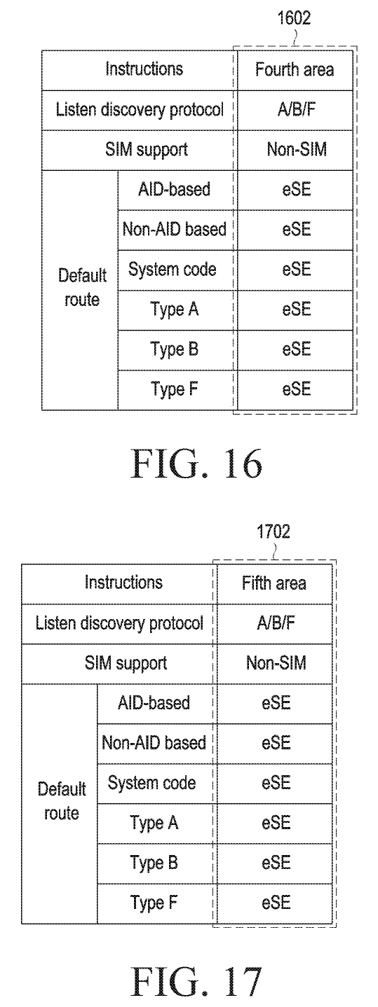

Referring to FIG. 16, the electronic device 101 may obtain a requested NFC configuration 1602 corresponding to Taiwan from a mobile payment application based on issuing a Taiwan transit card through the mobile payment application. In an embodiment, the requested NFC configuration 1602 may include area: Taiwan, NFCEE of a non-SIM type, and default route: eSE type. The electronic device 101 may determine to apply the requested NFC configuration 1602 to the NFC circuit 308 and may provide a transit card service in Taiwan through the eSE 608.

In an embodiment, when the electronic device 101 is positioned in France, a transit card service of France may use listen discovery protocol B. In an embodiment, since the electronic device 101 supports NFC protocol type A/F and NFCEE of a SIM type, it may not discover external electronic devices using listen discovery protocol B in France.

Referring to FIG. 17, the electronic device 101 may determine the current location as France and determine an NFC configuration 1702 (e.g., an NFC configuration corresponding to a non-SIM type among the NFC configuration 1120 of FIG. 11) corresponding to a fifth area including France as a first NFC configuration. In an embodiment, the NFC configuration 1702 may support listen discovery protocol A/B/F, support NFCEE of a non-SIM type, and have the default route for AID-based commands, non-AID-based commands, system code, and commands of NFC protocol type A/B/F as NFCEE of an eSE type.

In an embodiment, the electronic device 101 may determine to determine the NFC configuration 1702 corresponding to a non-SIM type to the NFC circuit 308, based on a default country (=Korea) of the electronic device 101 not matching a current location (=France). In an embodiment, the electronic device 101 may connect with external electronic devices of France according to NFC protocol type B and provide a transit card service, based on the NFC configuration 1702.

In an embodiment, the user may remove a Korean SIM from the electronic device 101 and insert a SIM 310 for use in France into the electronic device 101. In an embodiment, the SIM 310 for use in France may not support NFC feature, and the electronic device 101 may determine an NFC configuration 1702 corresponding to a non-SIM type among the NFC configuration 1120 corresponding to a fifth area including France as a first NFC configuration. The electronic device 101 may apply the NFC configuration 1702 to the NFC circuit 308 to provide a transit card service in France through the NFC circuit 308.

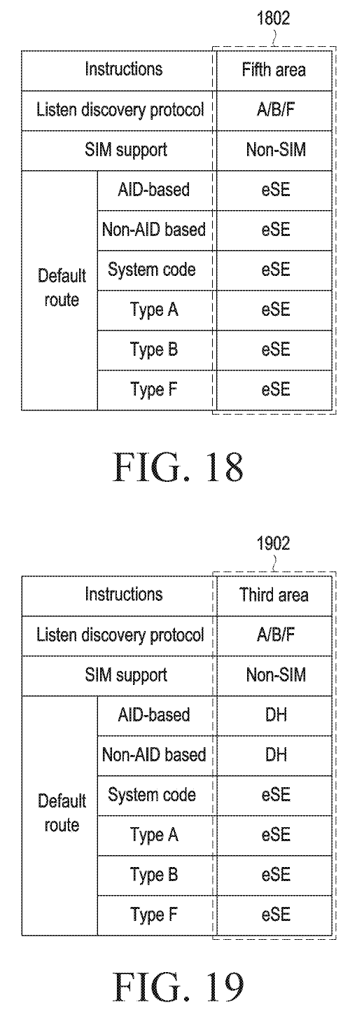

Referring to FIG. 18, the electronic device 101 may determine an NFC configuration 1802 (e.g., the NFC configuration 1112 of FIG. 11) corresponding to a first area including the United States as a first NFC configuration in order to use a student ID service in the United States. The NFC configuration 1802 may support listen discovery protocol A/B/F, support NFCEE of a non-SIM type, use NFCEE of a DH type as the default route for AID-based commands and non-AID-based commands, and use NFCEE of an eSE type as the default route for system code and commands of NFC protocol type A/B/F. In an embodiment, the electronic device 101 may apply the NFC configuration 1802 to the NFC circuit 308 to provide a student ID service through the NFC circuit 308 in the United States.

In an embodiment, the user may remove a Korean SIM from the electronic device 101 and insert a SIM 310 for use in the United States into the electronic device 101. In an embodiment, the SIM 310 for use in the United States may support NFC protocol type A/B. In an embodiment, the electronic device 101 may obtain the NFC configuration 1802 corresponding to a first area including the United States, and since the NFC configuration 1802 supports NFCEE of a non-SIM type, the electronic device 101 may apply the NFC configuration 1802 to the NFC circuit 308 to provide a student ID service through the NFC circuit 308 in the United States.

In an embodiment, the user may purchase an electronic device 101 having a default country set to the United States in the United States and insert a SIM 310 for use in the United States into the electronic device 101. In an embodiment, the SIM 310 for use in the United States may support NFC protocol type A/B, and since an NFC configuration 1802 corresponding to the United States supports NFCEE of a non-SIM type, the electronic device 101 may apply the NFC configuration 1802 to the NFC circuit 308 to provide NFC service through the NFC circuit 308 in the United States regardless of the capability of the SIM 310.

Referring to FIG. 19, a default country of the electronic device 101 is the United States, and the user may want to use a transit card service in Korea through the electronic device 101. In an embodiment, the electronic device 101 may determine an NFC configuration 1902 (e.g., an NFC configuration corresponding to a non-SIM type among the NFC configuration 1116 of FIG. 11) supporting NFCEE of a non-SIM type as a first NFC configuration in order to communicate with an external electronic device (e.g., the NFC reader 320) using NFC protocol type B. In an embodiment, the NFC configuration 1902 may support listen discovery protocol A/F, support NFCEE of a non-SIM type, and have the default route for AID-based commands, non-AID-based commands, system code, and commands of NFC protocol type A/B/F as NFCEE of an eSE type.

In an embodiment, the electronic device 101 may apply the NFC configuration 1902 to the NFC circuit 308 to cause the NFC circuit 308 to perform NFC operations based on the first NFC configuration, based on identifying that the NFC configuration 1902 indicates NFCEE of a non-SIM type. In an embodiment, the electronic device 101 may provide a transit card service in Korea through the NFC circuit 308 and the eSE 608 based on the NFC configuration 1902.

Embodiments of the disclosure may enable the electronic device 101 to use NFC service in an area where the electronic device 101 is currently positioned through an NFC configuration including an NFCEE type of the default route. In an embodiment, the electronic device 101 may be implemented as various types of devices capable of supporting NFC (e.g., a smart watch or a smart ring). In an embodiment, the electronic device 101 may control an external electronic device (e.g., a smart watch or a smart ring) paired with the electronic device 101 to perform NFC operations using an NFC configuration determined according to an embodiment of the disclosure, thereby enabling the user to use NFC service in a current area through the external electronic device.

Embodiments of the disclosure may enable the user to use NFC service in other countries by dynamically changing an NFC configuration of the electronic device 101 according to circumstances when the electronic device 101 is used in another country or when an NFC configuration of the electronic device 101 is not compatible with a desired service of a current country.

An electronic device 101 according to an embodiment of the disclosure may include an NFC circuit 308 configured to support at least one near-field communication (NFC) protocol, at least one processor 120, and memory 130 storing instructions. The instructions may, when executed by the at least one processor individually or collectively, cause the electronic device to obtain a first NFC configuration corresponding to at least one of the location information of the electronic device or a request from an application related to the NFC. The instructions may, when executed by the at least one processor individually or collectively, cause the electronic device to determine whether the first NFC configuration is supported by a subscriber identification module (SIM) 310 included in the electronic device. The instructions may, when executed by the at least one processor individually or collectively, cause the electronic device to, based on identifying whether the first NFC configuration is supported by the SIM, control the NFC circuit to perform NFC operations using the first NFC configuration or a second NFC configuration. The instructions may cause the electronic device to control the NFC circuit to perform NFC operations using the first NFC configuration based on identifying that the first NFC configuration is supported by the SIM. The instructions may cause the electronic device to obtain the second NFC configuration supporting NFC execution environments (NFCEE) of a non-SIM type and control the NFC circuit to perform NFC operations using the second NFC configuration, based on identifying that the first NFC configuration is not supported by the SIM.

In an embodiment, at least one of the first NFC configuration or the second NFC configuration may include at least one of listen discovery protocol information indicating at least one NFC protocol type to be used to perform NFC-based listen discovery, information indicating whether NFCEE of a SIM type is supported, and routing information indicating at least one NFCEE type associated with at least one default route to forward commands received from an external electronic device.

In an embodiment, the at least one NFCEE type may indicate at least one of a SIM type, an embedded secure element (eSE) type, or a device host (DH).

In an embodiment, the instructions may, when executed by the at least one processor individually or collectively, cause the electronic device to determine whether a current location of the electronic device is identified, determine the location information of the electronic device based on whether the current location of the electronic device identified, and obtain an NFC configuration corresponding to the location information and determine the obtained NFC configuration as the first NFC configuration. The instruction may cause the electronic device to determine a current country including the current location as the location information of the electronic device based on the current location of the electronic device being identified, and determine a default country set in the electronic device as the location information of the electronic device based on the current location of the electronic device not being identified.

In an embodiment, the instructions may, when executed by the at least one processor individually or collectively, cause the electronic device to obtain a requested NFC configuration for an application or a service related to NFC, and determine the first NFC configuration based on identifying whether a location corresponding to the requested NFC configuration being included in an area indicated by the location information. The instructions may cause the electronic device to determine the requested NFC configuration as the first NFC configuration based on the location corresponding to the requested NFC configuration being included in an area indicated by the location information, and obtain an NFC configuration corresponding to the location information and determine the obtained NFC configuration as the first NFC configuration based on the location corresponding to the requested NFC configuration is not included in the area indicated by the location information.

In an embodiment, the instructions may, when executed by the at least one processor individually or collectively, cause the electronic device to determine whether the first NFC configuration supports NFCEE of a SIM type based on identifying that an area corresponding to the first NFC configuration includes a default country of the electronic device or includes an area indicated by a mobile country code (MCC) obtained from the SIM, determine whether at least one NFC protocol included in the first NFC configuration is supported by the SIM based on the first NFC configuration supporting the NFCEE of the SIM type, and determine that the first NFC configuration is supported by the SIM based on the at least one NFC protocol included in the first NFC configuration being supported by the SIM.

In an embodiment, the instructions may, when executed by the at least one processor individually or collectively, cause the electronic device to determine that the first NFC configuration is not supported by the SIM based on identifying that an area corresponding to the first NFC configuration does not include a default country of the electronic device and not including an area indicated by an MCC obtained from the SIM.

In an embodiment, the instructions may, when executed by the at least one processor individually or collectively, cause the electronic device to determine that the first NFC configuration is not supported by the SIM based on identifying that the first NFC configuration does not support NFCEE of the SIM type or that at least one NFC protocol included in the first NFC configuration is not supported by the SIM.

In an embodiment, the instructions may, when executed by the at least one processor individually or collectively, cause the electronic device to determine, as the first NFC configuration, an NFC configuration corresponding to an area including a location indicated by the location information, among a plurality of NFC configurations corresponding to a plurality of areas stored in the memory.

In an embodiment, the instructions may, when executed by the at least one processor individually or collectively, cause the electronic device to obtain the first NFC configuration based on identifying that the electronic device is powered on, an airplane mode of the electronic device is activated or deactivated, an NFC feature of the electronic device is activated or deactivated, the SIM is recognized, the location information is obtained, or the request is received from the application.

A method performed by an electronic device 101 according to an embodiment of the disclosure may include obtaining (702) a first near-field communication (NFC) configuration corresponding to at least one of the location information of the electronic device or a request from an application related to NFC, determining (704) whether the first NFC configuration is supported by a subscriber identification module (SIM) 310 included in the electronic device, and performing NFC operations using the first NFC configuration or a second NFC configuration based on identifying whether the first NFC configuration is supported by the SIM. The performing (706) NFC operations comprises performing NFC operations using the first NFC configuration based on identifying that the first NFC configuration is supported by the SIM, and obtaining the second NFC configuration supporting NFC execution environments (NFCEE) of a non-SIM type and performing (708) NFC operations using the second NFC configuration, based on identifying that the first NFC configuration is not supported by the SIM.

In an embodiment, at least one of the first NFC configuration or the second NFC configuration may include at least one of listen discovery protocol information indicating at least one NFC protocol type to be used to perform NFC-based listen discovery, information indicating whether NFCEE of a SIM type is supported, and routing information indicating at least one NFCEE type associated with at least one default route to forward commands received from an external electronic device.

In an embodiment, the at least one NFCEE type may indicate at least one of a SIM type, an embedded secure element (eSE) type, or a device host (DH).

In an embodiment, the method may further include determining whether a current location of the electronic device is identified, determining the location information of the electronic device based on whether the current location of the electronic device is identified, and obtaining an NFC configuration corresponding to the location information and determining the obtained NFC configuration as the first NFC configuration. The determining the location information comprises determining a current country including the current location as the location information of the electronic device based on the current location of the electronic device being identified, and determining a default country set in the electronic device as the location information of the electronic device based on the current location of the electronic device not being identified.

In an embodiment, the method may further include obtaining a requested NFC configuration for an application or a service related to NFC, and determining the first NFC configuration based on identifying whether a location corresponding to the requested NFC configuration being included in an area indicated by the location information. The determining the first NFC configuration comprises determining the requested NFC configuration as the first NFC configuration based on the location corresponding to the requested NFC configuration being included in an area indicated by the location information, and obtaining an NFC configuration corresponding to the location information and determining the obtained NFC configuration as the first NFC configuration based on identifying that the location corresponding to the requested NFC configuration is not included in the area indicated by the location information.

In an embodiment, the method may further include determining whether the first NFC configuration supports NFCEE of a SIM type based on identifying that an area corresponding to the first NFC configuration includes a default country of the electronic device or includes an area indicated by a mobile country code (MCC) obtained from the SIM, determining whether at least one NFC protocol included in the first NFC configuration is supported by the SIM based on the first NFC configuration supporting the NFCEE of the SIM type, and determining that the first NFC configuration is supported by the SIM based on the at least one NFC protocol included in the first NFC configuration being supported by the SIM.

In an embodiment, the method may further include determining that the first NFC configuration is not supported by the SIM based on identifying that an area corresponding to the first NFC configuration does not includes a default country of the electronic device and not including an area indicated by an MCC obtained from the SIM.

In an embodiment, the method may further include determining that the first NFC configuration is not supported by the SIM based on identifying that the first NFC configuration does not support NFCEE of the SIM type or that at least one NFC protocol included in the first NFC configuration is not supported by the SIM.

In an embodiment, the method may further include determining, as the first NFC configuration, an NFC configuration corresponding to an area including a location indicated by the location information, among a plurality of NFC configurations corresponding to a plurality of areas stored in memory.

In an embodiment, the method may further include obtaining the first NFC configuration based on identifying that the electronic device is powered on, an airplane mode of the electronic device is activated or deactivated, an NFC feature of the electronic device is activated or deactivated, the SIM is recognized, the location information is obtained, or the request is received from the application.

In a non-transitory, computer-readable storage medium storing one or more programs, the one or more programs may include instructions that, when executed by at least one processor 120 of an electronic device 101 individually or collectively, cause the electronic device to obtain a first NFC configuration corresponding to the location information of the electronic device and/or a request from an application related to near-field communication (NFC), determine whether the first NFC configuration is supported by the SIM, perform NFC operations using the first NFC configuration based on identifying that the first NFC configuration is supported by the SIM, and obtain a second NFC configuration supporting NFC execution environments (NFCEE) of a non-SIM type and perform NFC operations using the second NFC configuration, based on identifying that the first NFC configuration is not supported by the SIM.

In an embodiment, the application related to NFC is a mobile payment application or a wallet application.

In an embodiment, the NFC configuration corresponding to a default country is set at a time of manufacturing the electronic device 101.

One or more non-transitory computer-readable storage media according to an embodiment of the disclosure may store one or more computer programs including computer-executable instructions that, when executed by one or more processors of an electronic device individually or collectively, cause the electronic device to perform operations. The operations comprises: obtaining a first near-field communication (NFC) configuration corresponding to at least one of location information of the electronic device or a request from an application related to NFC, determining whether the first NFC configuration is supported by a subscriber identification module (SIM) included in the electronic device, and based on identifying whether the first NFC configuration is supported by the SIM, performing NFC operations using the first NFC configuration or a second NFC configuration. The performing NFC operations comprises based on identifying that the first NFC configuration is supported by the SIM, performing NFC operations using the first NFC configuration, and based on identifying that the first NFC configuration is not supported by the SIM, obtaining the second NFC configuration supporting NFC execution environments (NFCEE) of a non-SIM type and performing NFC operations using the second NFC configuration.

In an embodiment, at least one of the first NFC configuration or the second NFC configuration includes at least one of listen discovery protocol information indicating at least one NFC protocol type to be used to perform NFC-based listen discovery, information indicating whether NFCEE of a SIM type is supported, and routing information indicating at least one NFCEE type associated with at least one default route to forward commands received from an external electronic device.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” "coupled to," "connected with," or “connected to” another element (e.g., a second element), it means that the element may be coupled with the other element directly (e.g., wiredly), wirelessly, or via a third element.

As used herein, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a near-field communication (NFC) circuit configured to support at least one NFC protocol;
memory storing instructions; and
at least one processor communicatively coupled to the NFC circuit and the memory,
wherein the instructions, when executed by the at least one processor individually or collectively, cause the electronic device to:
obtain a first NFC configuration corresponding to at least one of location information of the electronic device or a request from an application related to the NFC,
determine whether the first NFC configuration is supported by a subscriber identification module (SIM) included in the electronic device, and
based on identifying whether the first NFC configuration is supported by the SIM, control the NFC circuit to perform NFC operations using the first NFC configuration or a second NFC configuration,
wherein, based on identifying that the first NFC configuration is supported by the SIM, the instructions, when executed by the at least one processor individually or collectively, cause the electronic device to control the NFC circuit to perform NFC operations using the first NFC configuration, and
wherein, based on identifying that the first NFC configuration is not supported by the SIM, the instructions, when executed by the at least one processor individually or collectively, cause the electronic device to obtain the second NFC configuration supporting NFC execution environments (NFCEE) of a non-SIM type and control the NFC circuit to perform NFC operations using the second NFC configuration.

2. The electronic device of claim 1, wherein at least one of the first NFC configuration or the second NFC configuration includes at least one of:
listen discovery protocol information indicating at least one NFC protocol type to be used to perform NFC-based listen discovery;
information indicating whether NFCEE of a SIM type is supported; or
routing information indicating at least one NFCEE type associated with at least one default route to forward commands received from an external electronic device.

3. The electronic device of claim 2, wherein the at least one NFCEE type indicates at least one of a SIM type, an embedded secure element (eSE) type, or a device host (DH).

4. The electronic device of claim 1
wherein the instructions, when executed by the at least one processor individually or collectively, further cause the electronic device to:
determine whether a current location of the electronic device is identified,
based on whether the current location of the electronic device is identified, determine the location information of the electronic device, and
obtain an NFC configuration corresponding to the location information and determine the obtained NFC configuration as the first NFC configuration,
wherein, based on the current location of the electronic device being identified, the instructions cause the electronic device to determine a current country including the current location as the location information of the electronic device, and
wherein, based on the current location of the electronic device not being identified, the instructions cause the electronic device to determine a default country set in the electronic device as the location information of the electronic device.

5. The electronic device of claim 4,
wherein the instructions, when executed by the at least one processor individually or collectively, further cause the electronic device to:
obtain a requested NFC configuration for an application or a service related to NFC, and
based on identifying whether a location corresponding to the requested NFC configuration being included in an area indicated by the location information, determine the first NFC configuration,
wherein, based on a location corresponding to the requested NFC configuration being included in an area indicated by the location information, the instructions cause the electronic device to determine the requested NFC configuration as the first NFC configuration, and
wherein, based on the location corresponding to the requested NFC configuration being not included in the area indicated by the location information, the instructions cause the electronic device to obtain an NFC configuration corresponding to the location information and determine the obtained NFC configuration as the first NFC configuration.

6. The electronic device of claim 1, wherein the instructions, when executed by the at least one processor individually or collectively, further cause the electronic device to:
based on identifying that an area corresponding to the first NFC configuration includes a default country of the electronic device or includes an area indicated by a mobile country code (MCC) obtained from the SIM, determine whether the first NFC configuration supports NFCEE of a SIM type;
based on the first NFC configuration supporting the NFCEE of the SIM type, determine whether at least one NFC protocol included in the first NFC configuration is supported by the SIM; and
based on the at least one NFC protocol included in the first NFC configuration being supported by the SIM, determine that the first NFC configuration is supported by the SIM.

7. The electronic device of claim 6, wherein the instructions, when executed by the at least one processor individually or collectively, further cause the electronic device to:
based on identifying that an area corresponding to the first NFC configuration does not include a default country of the electronic device and not including an area indicated by an MCC obtained from the SIM, determine that the first NFC configuration is not supported by the SIM.

8. The electronic device of claim 7, wherein the instructions, when executed by the at least one processor individually or collectively, further cause the electronic device to:
based on identifying that the first NFC configuration does not support NFCEE of the SIM type or that at least one NFC protocol included in the first NFC configuration is not supported by the SIM, determine that the first NFC configuration is not supported by the SIM.

9. The electronic device of claim 1, wherein the instructions, when executed by the at least one processor individually or collectively, further cause the electronic device to determine, as the first NFC configuration, an NFC configuration corresponding to an area including a location indicated by the location information, among a plurality of NFC configurations corresponding to a plurality of areas stored in the memory.

10. The electronic device of claim 1, wherein the instructions, when executed by the at least one processor individually or collectively, further cause the electronic device to:
obtain the first NFC configuration based on identifying that:
the electronic device is powered on,
an airplane mode of the electronic device is activated or deactivated,
an NFC feature of the electronic device is activated or deactivated,
the SIM is recognized,
the location information is obtained, or
the request is received from the application related to NFC.

11. A method performed by an electronic device, the method comprising:
obtaining a first near-field communication (NFC) configuration corresponding to at least one of location information of the electronic device or a request from an application related to NFC;
determining whether the first NFC configuration is supported by a subscriber identification module (SIM) included in the electronic device; and
based on identifying whether the first NFC configuration is supported by the SIM, performing NFC operations using the first NFC configuration or a second NFC configuration,
wherein the performing NFC operations comprises:
based on identifying that the first NFC configuration is supported by the SIM, performing NFC operations using the first NFC configuration, and
based on identifying that the first NFC configuration is not supported by the SIM, obtaining the second NFC configuration supporting NFC execution environments (NFCEE) of a non-SIM type and performing NFC operations using the second NFC configuration.

12. The method of claim 11, wherein at least one of the first NFC configuration or the second NFC configuration includes at least one of:
listen discovery protocol information indicating at least one NFC protocol type to be used to perform NFC-based listen discovery;
information indicating whether NFCEE of a SIM type is supported; and
routing information indicating at least one NFCEE type associated with at least one default route to forward commands received from an external electronic device.

13. The method of claim 12, wherein the at least one NFCEE type indicates at least one of a SIM type, an embedded secure element (eSE) type, or a device host (DH).

14. The method of claim 11, further comprising:
determining whether a current location of the electronic device is identified;
based on whether the current location of the electronic device is identified, determining the location information of the electronic device; and
obtaining an NFC configuration corresponding to the location information and determining the obtained NFC configuration as the first NFC configuration,
wherein the determining the location information comprises:
based on the current location of the electronic device being identified, determining a current country including the current location as the location information of the electronic device, and
based on the current location of the electronic device not being identified, determining a default country set in the electronic device as the location information of the electronic device.

15. The method of claim 14, further comprising:
obtaining a requested NFC configuration for an application or a service related to NFC; and
based on identifying whether a location corresponding to the requested NFC configuration being included in an area indicated by the location information, determining the first NFC configuration,
wherein the determining the first NFC configuration comprises:
based on a location corresponding to the requested NFC configuration being included in an area indicated by the location information, determining the requested NFC configuration as the first NFC configuration, and
based on identifying that the location corresponding to the requested NFC configuration is not included in the area indicated by the location information, obtaining an NFC configuration corresponding to the location information and determining the obtained NFC configuration as the first NFC configuration.

16. The method of claim 11, further comprising:
based on identifying that an area corresponding to the first NFC configuration includes a default country of the electronic device or includes an area indicated by a mobile country code (MCC) obtained from the SIM, determining whether the first NFC configuration supports NFCEE of a SIM type;
based on the first NFC configuration supporting the NFCEE of the SIM type, determining whether at least one NFC protocol included in the first NFC configuration is supported by the SIM; and
based on the at least one NFC protocol included in the first NFC configuration being supported by the SIM, determining that the first NFC configuration is supported by the SIM.

17. The method of claim 16, further comprising, based on identifying that an area corresponding to the first NFC configuration does not include a default country of the electronic device and not including an area indicated by an MCC obtained from the SIM, determining that the first NFC configuration is not supported by the SIM.

18. The method of claim 17, further comprising, based on identifying that the first NFC configuration does not support NFCEE of the SIM type or that at least one NFC protocol included in the first NFC configuration is not supported by the SIM, determining that the first NFC configuration is not supported by the SIM.

19. The method of claim 11, further comprising determining, as the first NFC configuration, an NFC configuration corresponding to an area including a location indicated by the location information, among a plurality of NFC configurations corresponding to a plurality of areas stored in memory.

20. The method of claim 11, further comprising:
obtaining the first NFC configuration based on identifying that:
the electronic device is powered on,
an airplane mode of the electronic device is activated or deactivated,
an NFC feature of the electronic device is activated or deactivated,
the SIM is recognized,
the location information is obtained, or
the request is received from the application.
